(19) United States
(12) Patent Application Publication
(10) Pub. No.: US 2019/0010383 A1
(43) Pub. Date: Jan. 10, 2019

(54) SELF-DEGRADABLE DIVERTERS FOR PROPPED FRACTURE ACIDIZING

(71) Applicant: Halliburton Energy Services, Inc., Houston, TX (US)

(72) Inventors: Prasad Baburao Karadkar, Al-Khobar (SA); Joao Walter Pereira Suzart, Salvador (BR); Anupom Sabhapondit, Al-Khobar (SA)

(21) Appl. No.: 16/066,173

(22) PCT Filed: Mar. 18, 2016
(86) PCT No.: PCT/US2016/023204

§ 371 Date: Jun. 26, 2018

(51) Int. Cl. C09K 8/68; C09K 8/70; C09K 8/92; C09K 8/88; C09K 8/80

(52) U.S. Cl. CPC C09K 8/68; C09K 8/70; C09K 8/92; E21B 43/267; C09K 8/80; C09K 2208/32; C09K 8/885

(57) ABSTRACT

Methods for treatment fluids that include an acid source, a self-degradable particulate material, and a propping agent for use in subterranean treatments are provided. In one embodiment, the methods comprise providing a treatment fluid comprising a base fluid; an acid source; a self-degradable particulate material; and a propping agent; introducing the treatment fluid into a wellbore penetrating at least a first portion of a subterranean formation at or above a pressure sufficient to create or enhance one or more fractures in the subterranean formation; and allowing the self-degradable particulate material to divert at least a portion of the treatment fluid into a second portion of the subterranean formation.

### BACKGROUND

The present disclosure relates to systems and methods for treating subterranean formations using acid fracturing.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, acidizing operations, and the like.

To facilitate the production of hydrocarbons from a subterranean formation, it is a common practice to stimulate subterranean formations with treatment fluids in order to increase the conductivity and productions thereof. Stimulation operations may involve hydraulic fracturing, acidizing, fracture acidizing, or other suitable stimulation operations. Once the stimulation operation has been completed and after any intermediate steps, the well bore may be placed into production.

Hydraulic fracturing operations generally involve pumping a treatment fluid (e.g., a fracturing fluid or a “pad fluid”) into a well bore that penetrates a subterranean formation at or above a sufficient hydraulic pressure to create or enhance one or more pathways, or “fractures,” in the subterranean formation. These fractures generally increase the permeability and/or conductivity of that portion of the formation. The fluid may comprise propping agents or particulates, often referred to as “proppant particulates,” that are deposited in the resultant fractures. The proppant particulates are thought to help prevent the fractures from fully closing upon the release of the hydraulic pressure, forming conductive channels through which fluids may flow to a well bore.

Formation acidizing, or “acidizing,” is a stimulation method for increasing the flow of desirable hydrocarbons from a subterranean formation using an acidic treatment fluid. In some instances, both acidizing and fracturing may be performed in a subterranean formation. In some instances, a formation may be sequentially treated with both acidizing and fracturing to maximize fracture conductivity. In other instances, acidizing and fracturing may be performed simultaneously in a single treatment.

In typical stimulation operations of subterranean formations, stimulation treatments may be performed in multiple stages. These multiple stage treatments may be performed simultaneously, or the multiple stage stimulation treatments may be performed sequentially. Multiple stage treatments are especially desirable when well bores are completed in multi-zones that have high permeability contrast. In each stage, it is often desirable to divert the treatment fluids away from more permeable zones, causing the treatment fluid to be diverted to less permeable zones of the formation. Recently, certain aliphatic polyester-based diverting agents have been used in traditional hydraulic fracturing operations based on their ability to self-degrade in aqueous fluids.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is a diagram illustrating an example of a portion of a subterranean formation with multiple zones in which self-degradable particulate material may be used in accordance with certain embodiments of the present disclosure.

FIG. 4 is a graph illustrating data relating to rheological properties of viscosified and non-viscosified CEA fluids.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to systems and methods for treating subterranean formations. More particularly, the present disclosure relates to systems and methods for simultaneous proppant and acid fracturing using diverting agents.

The treatment fluids of the present disclosure generally comprise at least a base fluid, an acid source, a propping agent, and a self-degradable particulate material and certain methods of use. In certain embodiments, the methods of the present disclosure comprise providing a treatment fluid comprising at least a base fluid, an acid source, a propping agent, and a self-degradable particulate material, introducing the treatment fluid into a wellbore penetrating at least a first portion of a subterranean formation at or above a pressure sufficient to create or enhance one or more fractures in the subterranean formation, and allowing the self-degradable particulate material to divert the flow of at least a portion of the treatment fluid into a second portion of the subterranean formation. In certain embodiments, these methods may be used in fracture acidizing treatments in order to facilitate the production of hydrocarbons from a formation.

The term “degradable” as used herein in reference to the self-degradable particulate material of the present disclosure means that the material is degradable due, inter alia, to chemical and/or radical degradation processes such as hydrolysis or oxidation. For example, a composition may be said to have degraded when it has undergone a chemical breakdown. Methods of degradation include, but are not limited to, melting, hydrolysis, solventolysis, oxidation, or complete dissolution.

The term “derivative” is used herein to include any compound that is made from one of the listed compounds, for example, by replacing one atom in the listed compound with another atom or group of atoms, rearranging two or more atoms in the listed compound, ionizing the listed compounds, or creating a salt of the listed compound.

Among the many potential advantages to the methods and compositions of the present disclosure, only some of which are alluded to herein, the methods, compositions, and systems of the present disclosure may be used for fracture acidizing operations. In certain embodiments, the methods and compositions of the present disclosure may facilitate the stimulation and treatment of less permeable zones of a formation. Moreover, in some embodiments, the self-degradable diverter materials may reduce or eliminate the need to physically or chemically remove or drill through the diverting agents, thereby reducing time and saving money during operations. In certain embodiments, the methods and compositions of the present disclosure may also be used with emulsified acid systems. It is believed that the self-degrading nature of the diverter materials of the present disclosure enhances the conductivity of proppant packs within subterranean formations, thereby increasing production of oil or gas. Additionally, the methods and compositions of the present disclosure may be used in treatment operations for carbonate formations.

The treatment fluids used in the methods and systems of the present disclosure may comprise any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons, organic liquids, and the like. In certain embodiments, the fracturing fluids may comprise a mixture of one or more fluids and/or gases, including but not limited to emulsions, foams, and the like.

The treatment fluids used in the methods and systems of the present disclosure may comprise an acid source. In certain embodiments, the acid source of the present disclosure may comprise any acid suitable for use in acidizing treatments, such as fracture acidizing. In certain embodiments, the acids may be organic acids or inorganic acids, or any combination thereof. Examples of suitable acids for use in various embodiments include, but are not limited to: hydrochloric acid, hydrofluoric acid, formic acid, acetic acid, citric acid, glycolic acid, hydroxyacetic acid, lactic acid, hydrofluoric acid, 3-hydroxypropionic acid, carbonic acid, and ethylenediaminetetraacetic acid. Alternatively or in combination with one or more acids, the acid source of the present disclosure may comprise a salt of an acid. A “salt” of an acid, as that term is used herein, refers to any compound that shares the same base formula as the referenced acid, but one of the hydrogen cations thereon is replaced by a different cation (e.g., an antimony, bismuth, potassium, sodium, calcium, magnesium, cesium, or zinc cation). Examples of suitable salts of acids include, but are not limited to, sodium acetate, sodium formate, sodium citrate, sodium hydroxyacetate, sodium lactate, sodium fluoride, sodium propionate, sodium carbonate, calcium acetate, calcium formate, calcium citrate, calcium hydroxyacetate, calcium lactate, calcium fluoride, calcium propionate, calcium carbonate, cesium acetate, cesium formate, cesium citrate, cesium hydroxyacetate, cesium lactate, cesium fluoride, cesium propionate, cesium carbonate, potassium acetate, potassium formate, potassium citrate, potassium hydroxyacetate, potassium lactate, potassium fluoride, potassium propionate, potassium carbonate, magnesium acetate, magnesium formate, magnesium citrate, magnesium hydroxyacetate, magnesium lactate, magnesium fluoride, magnesium propionate, magnesium carbonate, zinc acetate, zinc formate, zinc citrate, zinc hydroxyacetate, zinc lactate, zinc fluoride, zinc propionate, zinc carbonate, antimony acetate, antimony formate, antimony citrate, antimony hydroxyacetate, antimony lactate, antimony fluoride, antimony propionate, antimony carbonate, bismuth acetate, and bismuth formate, bismuth citrate, bismuth hydroxyacetate, bismuth lactate, bismuth fluoride, bismuth carbonate, and bismuth propionate. The treatment fluids of some embodiments of the present disclosure may include any combination of two or more acids and/or salts thereof.

In certain embodiments, the acid source may be present in the treatment fluids of the present disclosure in an amount sufficient to make the treatment fluids acidic. In certain embodiments, the pH may be less than about 7. In other embodiments, the pH of the treatment fluid may be less than about 6, or in other embodiments, less than about 5. In certain embodiments, the treatment fluid may be strongly acidic (e.g., having a pH less than about 3, or in other embodiments, less than about 2). In certain embodiments, the pH may be approximately 0. So, for example, in certain embodiments the acid source may be present in the range of from about 1% by weight of the treatment fluid to about 30% by weight of the treatment fluid. In certain embodiments, the acid source may be present in the treatment fluid in the range of from about 5% by weight of the treatment fluid to about 30% by weight of the treatment fluid. In other embodiments, the acid source may be 100% by weight of the treatment fluid (prior to addition of self-degradable particulate material and any other additives discussed herein).

The treatment fluids used in the systems and methods of the present disclosure also comprise a self-degradable particulate material. In certain embodiments, the self-degradable particulate material is used as a diverting agent. The choice of a diverting material, including the desired size and shape of any particulate diverting material, in the methods of the present disclosure may depend on, among other factors, the type of subterranean formation (e.g., rock characteristics), the presence or absence of a casing in the subterranean formation, the composition of the treatment fluid(s) to be used, the temperature of the subterranean formation, the size of the perforations, the desired timing and rate for its degradation, and any subsequent treatments to be performed following the method of the present disclosure. For example, if the diverting material is to be placed in a portion of a well bore that is uncased, a diverting material should be chosen that it is capable of forming a filter cake on the inside wall of the well bore. In other embodiments, the particle size of a particulate diverting material may be selected such that the fluid permeability of those particulates in a pack is relatively low. In certain embodiments, the self-degradable particulate material may be present in a concentration of from about 0.2 pptg to about 10 pptg. A person of skill in the art will recognize suitable and/or preferred materials for the diverting materials for a particular application of the present disclosure with the benefit of this disclosure in view of these and other factors.

In certain embodiments, this self-degradable material may be selected as a material that degrades or dissolves in the presence of the fluid used to treat the less fluid flow-resistant portion of the subterranean formation (or a component thereof) and/or an intermediate fluid introduced into the formation after the more fluid flow-resistant portion of the formation has been treated. In certain embodiments, the self-degradable material may be selected as a material that simply degrades with the passage of time. Examples of suitable self-degradable particulate material may include polyesters, orthoesters, poly(orthoesters), polyanhydrides, polylactic acid, dehydrated organic or inorganic compounds, anhydrous borate, salts of organic acids, any combination thereof, or any derivative thereof. Examples of commercially available self-degradable particulate materials that may be suitable for use in certain, embodiments of the present disclosure are BioVert® H-150, BioVert® NWB and Guidon AGS™, available from Halliburton Energy Services, Inc., Houston, Tex.

In certain embodiments, the treatment fluids used in the methods and systems of the present disclosure may comprise an emulsion. The emulsions of the present disclosure generally comprise two or more immiscible liquids, such as a polar (aqueous) fluid and a nonpolar (oil-based) fluid. In certain embodiments, the emulsions of the present disclosure may be traditional emulsions (e.g., emulsions having an aqueous external phase and an oil-based internal phase). In certain embodiments, the emulsions of the present disclosure may be invert emulsions (e.g., emulsions having an oil-based external phase and an aqueous internal phase). The aqueous phase of the emulsions may comprise water from any source. Suitable aqueous fluids may comprise fresh water, salt water (e.g., water containing one or more salts dissolved therein), brine (e.g., saturated salt water), seawater, or any combination thereof. The oil-based phase may comprise any type of oil-based liquid. Examples of oil-based liquids that may be suitable for use in the methods and systems of the present disclosure include, but are not limited to, oils, hydrocarbons, esters, ethers, non-polar organic liquids, and the like. In certain embodiments, the oil-based liquid may be diesel oil. The two phases of the emulsion may be included in any suitable amounts and/or ratios. For example, in certain embodiments, the emulsion may comprise an aqueous phase and an oil phase in a ratio of from about 99:1 to about 1:99. In certain embodiments, the emulsion of the present disclosure may be a water-in-oil emulsified acid. One example of a commercially available emulsified acid that may be suitable for use in certain embodiments of the present disclosure is Carbonate Emulsion™ acid (“CEA”) available from Halliburton Energy Services, Inc., Houston, Tex.

In certain embodiments, the treatment fluids used in the methods and systems of the present disclosure may include an emulsifier. The emulsifier may be an emulsifying surfactant or any other emulsifier suitable to lower the interfacial tension between oil and water to allow stable emulsion formation. Depending upon the particular application of the methods of the present disclosure, the surfactant may be cationic, anionic, nonionic, or amphoteric, and may be monomeric or polymeric. Types of cationic surfactants that may be suitable for certain embodiments of the present disclosure include, but are not limited to, arginine methyl esters, alkanolamines, alkylenediamines, alkyl amines, alkyl amine salts, quaternary ammonium salts such as trimethyltallowammonium chloride, amine oxides, alkyltrimethyl amines, triethyl amines, alkyldimethylbenzylamines, alkylamidobetaines such as cocoamidopropyl betaine, alpha-olefin sulfonate, C8 to C22 alkylethoxylate sulfate, trimethylcocoammonium chloride, derivatives thereof, and combinations thereof. Types of anionic surfactants that may be suitable for certain embodiments of the present disclosure include, but are not limited to, alkali metal alkyl sulfates, alkyl ether sulfonates, alkyl sulfonates, alkylaryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, phosphate esters alkyl carboxylates, alkylether carboxylates, N-acylaminoacids, N-acylglutamates, N-acylpolypeptides, alkylbenzenesulfonates, paraffinic sulfonates, α-olefin sulfonates, lignosulfates, derivatives of sulfosuccinates, polynapthylmethylsulfonates, alkyl sulfates, alkylethersulfates, monoalkylphosphates, polyalkylphosphates, fatty acids, alkali salts of acids, alkali salts of fatty acids, alkaline salts of acids, sodium salts of acids, sodium salts of fatty acid, alkyl ethoxylate, soaps, derivatives thereof, and combinations thereof. Types of non-ionic surfactants that may be suitable for certain embodiments of the present disclosure include, but are not limited to, amides, diamides, polyglycol esters, alkyl polyglycosides, sorbitan esters, methyl glucoside esters and alcohol ethoxylates alcohol oxylalkylates, alkyl phenol oxylalkylates, nonionic esters such as sorbitan esters alkoxylates of sorbitan esters, castor oil alkoxylates, fatty acid alkoxylates, lauryl alcohol alkoxylates, nonylphenol alkoxylates, octylphenol alkoxylates, and tridecyl alcohol alkoxylates. Examples of non-ionic surfactants that may be suitable include, but are not limited to, alkylphenol ethoxylates, nonylphenol ethoxylates, octylphenol ethoxylates, tridecyl alcohol ethoxylates, mannide monooleate, sorbitan isostearate, sorbitan laurate, sorbitan monoisostearate, sorbitan monolaurate, sorbitan monooleate, sorbitan monopalmitate, sorbitan monostearate, sorbitan oleate, sorbitan palmitate, sorbitan sesquioleate, sorbitan stearate, sorbitan trioleate, sorbitan tristearate, and the like.

The treatment fluids used in the systems and methods of the present disclosure also comprise propping agents. The propping agents used in the methods and systems of the present disclosure may comprise any suitable particulate material known in the art that is capable of being deposited in one or more of the fractures in the formation (whether created, enhanced, and/or pre-existing). Examples of propping agents may include: bubbles or microspheres, such as made from glass, ceramic, polymer, sand, and/or another material. Other examples of propping agents may include particles of any one or more of: calcium carbonate (CaCO₃); barium sulfate (BaSO₄); organic polymers; cement; boric oxide; slag; sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and combinations thereof. Suitable composite particulates may comprise a binder and a filler material wherein suitable filler materials may include any one or more of: silica; alumina; fumed carbon; carbon black; graphite; mica; titanium dioxide; meta-silicate; calcium silicate; kaolin; talc; zirconia; boron; fly ash; hollow glass microspheres; solid glass; and combinations thereof.

In certain embodiments, the treatment fluids used in the methods and systems of the present disclosure optionally may comprise one or more viscosifiers, which may comprise any substance that is capable of increasing the viscosity of a fluid, for example, by forming a gel. Examples of viscosifiers that may be suitable for use in accordance with the present disclosure include, but are not limited to guar, guar derivatives (e.g., hydroxyethyl guar, hydroxypropyl guar, carboxymethyl guar, carboxymethylhydroxyethyl guar, and carboxymethylhydroxypropyl guar (“CMHPG”)), cellulose, cellulose derivatives (e.g., hydroxyethyl cellulose, carboxyethylcellulose, carboxymethylcellulose, and carboxymethylhydroxyethylcellulose), biopolymers (e.g., xanthan, scleroglucan, diutan, etc.), starches, chitosans, clays, polyvinyl alcohols, acrylamides, acrylates, viscoelastic surfactants (e.g., methyl ester sulfonates, hydrolyzed keratin, sulfosuccinates, taurates, amine oxides, ethoxylated amides, alkoxylated fatty acids, alkoxylated alcohols, ethoxylated fatty amines, ethoxylated alkyl amines, betaines, modified betaines, alkylamidobetaines, etc.), combinations thereof, and derivatives thereof. In certain embodiments, the viscosifiers may be “crosslinked” with a crosslinking agent, among other reasons, to impart enhanced viscosity and/or suspension properties to the fluid. The viscosifiers may be included in any concentration sufficient to impart the desired viscosity and/or suspension properties to the fluid. In certain embodiments, the viscosifier may be included in an amount of from about 0.1% to about 10% by weight of the fluid. In other embodiments, the viscosifier may be present in the range of from about 0.1% to about 5% by weight of the fluid.

In certain embodiments, the treatment fluids used in the methods and systems of the present disclosure optionally may comprise one or more corrosion inhibitors or corrosion inhibitor intensifiers. Examples of corrosion inhibitors that may be suitable for use in certain embodiments of the present disclosure include acetylenic alcohols, Mannich condensation products (such as those formed by reacting an aldehyde, a carbonyl containing compound and a nitrogen containing compound), unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, combinations of such compounds used in conjunction with iodine; quaternary ammonium compounds; and combinations thereof. Examples of commercially available corrosion inhibitors that may be suitable for use in certain embodiments of the present disclosure are HAI-404M™, HII-124B™, and HII-124F™ available from Halliburton Energy Services, Inc., Houston, Tex.

In certain embodiments, the treatment fluids used in the methods and systems of the present disclosure optionally may comprise any number of additional additives. Examples of such additional additives include, but are not limited to, salts, surfactants, fluid loss control additives, gas, nitrogen, carbon dioxide, surface modifying agents, tackifying agents, foamers, scale inhibitors, catalysts, clay control agents, biocides, friction reducers, antifoam agents, bridging agents, flocculants, H₂S scavengers, CO₂ scavengers, oxygen scavengers, lubricants, breakers, weighting agents, relative permeability modifiers, resins, wetting agents, coating enhancement agents, filter cake removal agents, antifreeze agents (e.g., ethylene glycol), and the like. In certain embodiments, one or more of these additional additives may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The treatment fluids of the present disclosure may be prepared using any suitable method and/or equipment (e.g., blenders, mixers, stirrers, etc.) known in the art at any time prior to their use. The treatment fluids may be prepared at least in part at a well site or at an offsite location. In certain embodiments, the self-degradable particulate material and/or other components of the treatment fluid may be metered directly into a base treatment fluid to form a treatment fluid. In certain embodiments, the base fluid may be mixed with the self-degradable particulate material and/or other components of the treatment fluid at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the treatment fluids of the present disclosure may be prepared, either in whole or in part, at an offsite location and transported to the site where the treatment or operation is conducted. In introducing a treatment fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

The present disclosure in some embodiments provides methods for using the treatment fluids to carry out a variety of subterranean treatments, including but not limited to, hydraulic fracturing treatments and fracture acidizing treatments. In certain embodiments, a treatment fluid may be introduced into a subterranean formation. In some embodiments, the treatment fluid may be introduced into a well bore that penetrates a subterranean formation. In some embodiments, the treatment fluid may be introduced at a pressure sufficient to create or enhance one or more fractures within the subterranean formation.

In some embodiments, the treatment fluid comprising an acid source and self-degradable particulate material may be introduced at a pressure sufficient to cause at least a portion of the treatment fluid to penetrate at least a portion of the subterranean formation, and the treatment fluid may be allowed to interact with the subterranean formation so as to create one or more voids in the subterranean formation. Introduction of the treatment fluid may in some of these embodiments be carried out at or above a pressure sufficient to create or enhance one or more fractures within the subterranean formation (e.g., fracture acidizing).

In certain fracturing treatments, propping agents may be introduced into a subterranean formation by sequentially injecting into the well bore alternating stages or pulses of treatment fluids carrying different amounts of propping agents (e.g., fluids comprising substantially no propping agents or comprising a propping agent in an amount less than the treatment fluid (also referred to herein as a “clean fluid”), fluids containing propping agents in varying amounts, etc.). These methods have been described as forming “pillars” of propping agents in the open space of a fracture and flow channels between those pillars which may optimize the conductivity of the fracture. One example of a commercially available service that has provided these types of treatments is Conductor^{SM} Fracturing Service, available from Halliburton Energy Services, Inc., Houston, Tex.

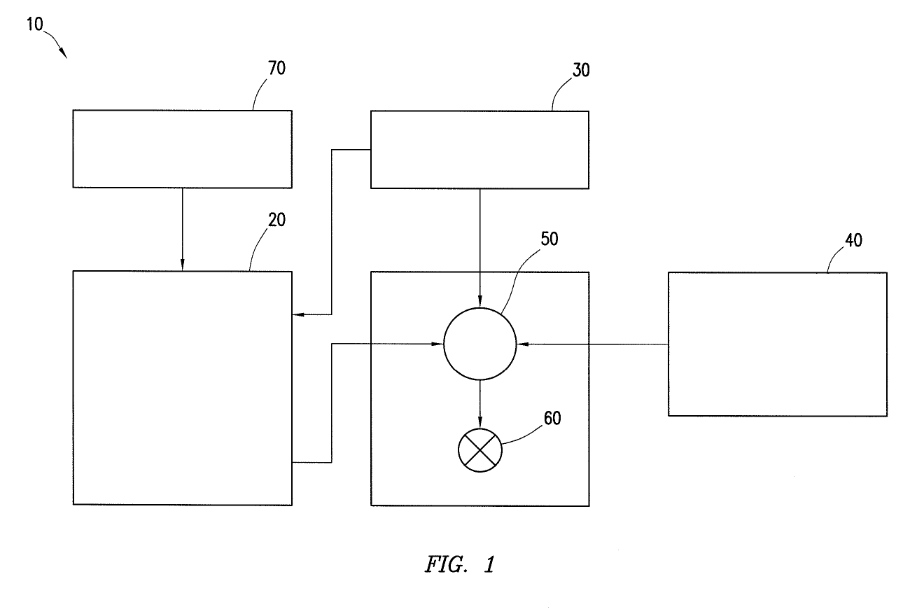

Certain embodiments of the methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a propping agent source 40, and a pump and blender system 50 and resides at the surface at a well site where a well 60 is located. In certain instances, the fracturing fluid producing apparatus 20 combines a self-degradable particulate material with fluid (e.g., liquid or substantially liquid) from fluid source 30, to produce a fracturing fluid that may be used to fracture the formation. The fracturing fluid can be a fluid ready for use in a fracture stimulation treatment of the well 60 or a concentrate to which additional fluid is added prior to use in a fracture stimulation of the well 60. In some embodiments, the fracturing fluid producing apparatus 20 can be omitted and the fracturing fluid sourced directly from the fluid source 30. In certain embodiments, the fracturing fluid may comprise water, a hydrocarbon fluid, a polymer gel, foam, air, wet gases and/or other fluids.

The propping agent source 40 can include a propping agent for combination with the fracturing fluid. In certain embodiments, one or more treatment particulates of the present disclosure may be provided in the propping agent source 40 and thereby combined with the fracturing fluid with the propping agent. The system may also include additive source 70 that provides one or more additives (e.g., gelling agents, surfactants, weighting agents, and/or other additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including propping agent from the propping agent source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or propping agent source 40 may be equipped with one or more metering devices (not shown) to control the flow of fluids, self-degradable particulate material, propping agents, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just propping agents at other times, and combinations of those components at yet other times.

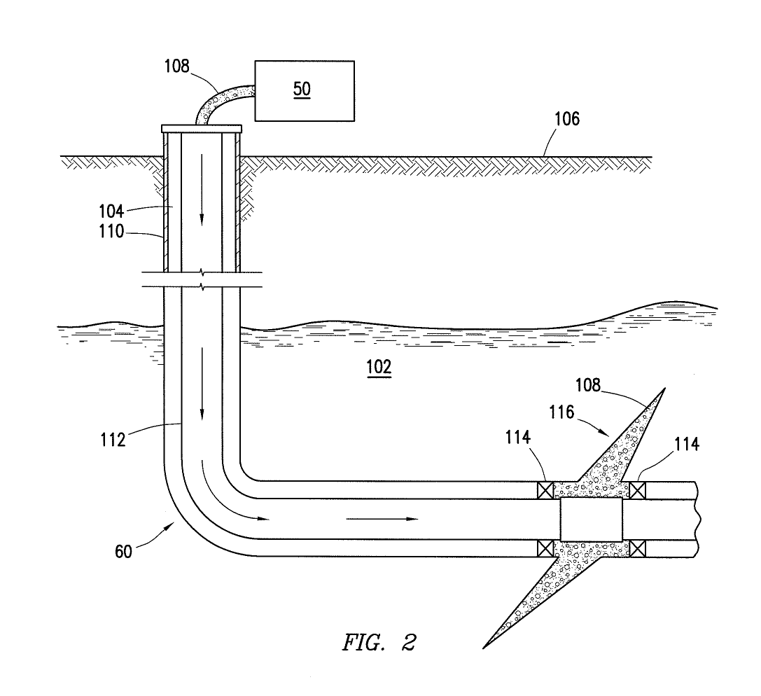

FIG. 2 shows the well 60 during a fracturing operation in a portion of a subterranean formation of interest 102 surrounding a wellbore 104. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the wellbore 104. The pump and blender system 50 is coupled to a work string 112 to pump the fracturing fluid 108 into the wellbore 104. The working string 112 may include coiled tubing, jointed pipe, and/or other structures that allow fluid to flow into the wellbore 104. The working string 112 can include flow control devices, bypass valves, ports, and or other tools or well devices that control a flow of fluid from the interior of the working string 112 into the subterranean zone 102. For example, the working string 112 may include ports adjacent the wellbore wall to communicate the fracturing fluid 108 directly into the subterranean formation 102, and/or the working string 112 may include ports that are spaced apart from the wellbore wall to communicate the fracturing fluid 108 into an annulus in the wellbore between the working string 112 and the wellbore wall.

The working string 112 and/or the wellbore 104 may include one or more sets of packers 114 that seal the annulus between the working string 112 and wellbore 104 to define an interval of the wellbore 104 into which the fracturing fluid 108 will be pumped. FIG. 2 shows two packers 114, one defining an uphole boundary of the interval and one defining the downhole end of the interval. When the fracturing fluid 108 is introduced into wellbore 104 (e.g., in FIG. 2, the area of the wellbore 104 between packers 114) at a sufficient hydraulic pressure, one or more fractures 116 may be created in the subterranean zone 102. The propping agents (and/or treatment particulates of the present disclosure) in the fracturing fluid 108 may enter the fractures 116 where they may remain after the fracturing fluid flows out of the wellbore. These propping agents may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

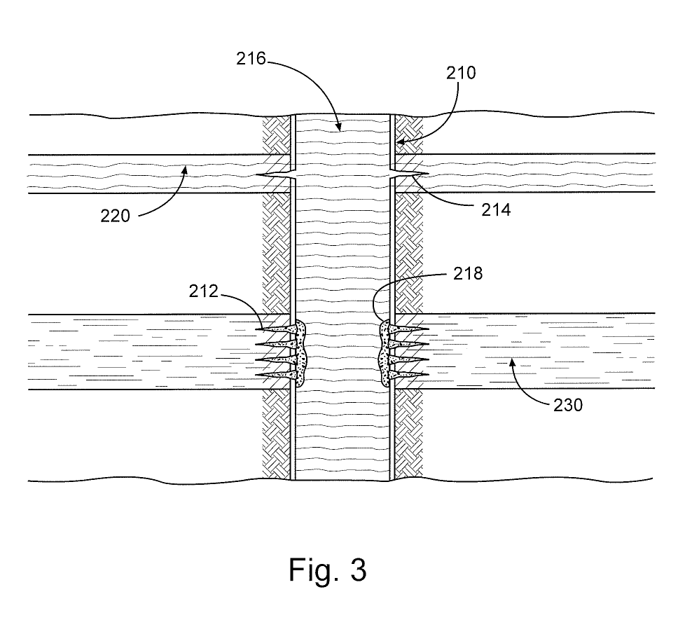

FIG. 3 shows a side view of a subterranean formation penetrated by a well bore 216 with a casing string 210 placed in the well bore 216. The well bore 216 penetrates two zones 220 and 230 in the subterranean formation, wherein the fluid flow resistance of zone 220 is higher than the fluid flow resistance of zone 230. Perforations 212, 214 have been created in the casing string 210 to allow for fluid flow into the zones 220 and 230. In certain embodiments, a treatment fluid of the present disclosure comprising a self-degradable particulate material may be introduced into at least a portion of the perforations 214 within zone 230 or adjacent to a least a portion of zone 230 of the subterranean formation using one or more pumps.

Once introduced into the well bore 216, the self-degradable particulate material may form a bridge 218 to plug or partially plug zone 230. The treatment fluid may then be diverted by bridge 218 to the less permeable zone 220 of the subterranean formation. The treatment fluid may then create or enhance one or more fractures in the less permeable zone 220 of the subterranean formation.

After diverting the treatment fluid, bridge 218 may degrade over time to at least partially unplug zone 230 without having to perform secondary cleanup operations to remove the self-degradable particulate material from the permeable zone. In another embodiment, this diverting procedure may be repeated with respect to each of a second, third, fourth, or more, treatment stages (not shown) to divert the treatment fluid to further less permeable zones of the subterranean formation.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLES

### Viscosified Emulsified Acid Composition

In this example, an illustrative treatment fluid was prepared from a viscosified emulsified acid system. The viscosified emulsified acid systems were prepared by viscosifying a CEA system. Table 1 shows the overall formulation of the viscosified CEA fluid.

TABLE 1
Viscosified CEA fluid formulation.

| | | |
|---|---|---|
| Additive | Concentration | Units |

Aqueous/Acid Phase - 70%

| | | |
|---|---|---|
| Fresh Water | 111 | gal/1000 gal |
| HII-124B ™ | 80 | gal/1000 gal |
| HAI-404M ™ | 8 | gal/1000 gal |
| 31% Hydrochloric Acid | 573 | lb/1000 gal |
| HII-124F ™ | 5 | gal/1000 gal |

Diesel Phase - 30%

| | | |
|---|---|---|
| Diesel | 285 | gal/1000 gal |
| AF-70 ™ | 15 | gal/1000 gal |

Viscosifier

| | | |
|---|---|---|
| BDF-570 ™ | 10 | gal/1000 gal |

The trademarked additives listed in Table 1 above are all commercially available from Halliburton Energy Services, Inc., Houston, Tex. HII-124B™, HAI-404M™, and HII-124F™ are corrosion inhibitors and corrosion inhibitor intensifiers. AF70™ is an acid emulsifier. The CEA system in this example was prepared by first slowly adding the acid phase to the diesel phase under shear to create an oil-external emulsion. Next, to increase the viscosity of the system, BDF570™ was added to the CEA while mixing in a Warring blender. The oil-external characteristic of the viscosified CEA formulation was confirmed using a drop test, wherein a drop of the viscosified CEA was added to water using a spatula.

### Viscosified CEA Testing

The viscosified CEA formulation described in Table 1 above was tested to confirm the temperature stability of the emulsion. The viscosified CEA was held at 300° F. for two hours in pressurized ageing cells, and no emulsion break was observed. Afterwards, the oil-external characteristic of the heat-treated viscosified CEA was re-confirmed using the same drop test as described above.

The viscosified CEA formulation also underwent two separate sets of viscosity tests. Table 2 shows the results of the first of these tests, wherein the viscosity of the viscosified CEA system was measured at increasing temperatures. All results were measured using a Chandler 5550 Model 50 type viscometer. The first measurements were taken at a temperature of 100° F. Viscosity measurements were then taken in 50° F. increments up to a final temperature of 300° F. The tests were conducted at 1000 psi and at shear rates of 50 l/s and 100 l/s.

TABLE 2
Viscosified CEA viscosities at different temperature and shear rates.

| Temperature, ° F. | Shear Rate, l/s | Viscosity, cP |
|---|---|---|
| 100 | 50 | 2424 |
| | 100 | 1056 |
| 150 | 50 | 2058 |
| | 100 | 978 |
| 200 | 50 | 917 |
| | 100 | 628 |
| 250 | 50 | 380 |
| | 100 | Not evaluated |
| 300 | 50 | 306 |
| | 100 | 153 |

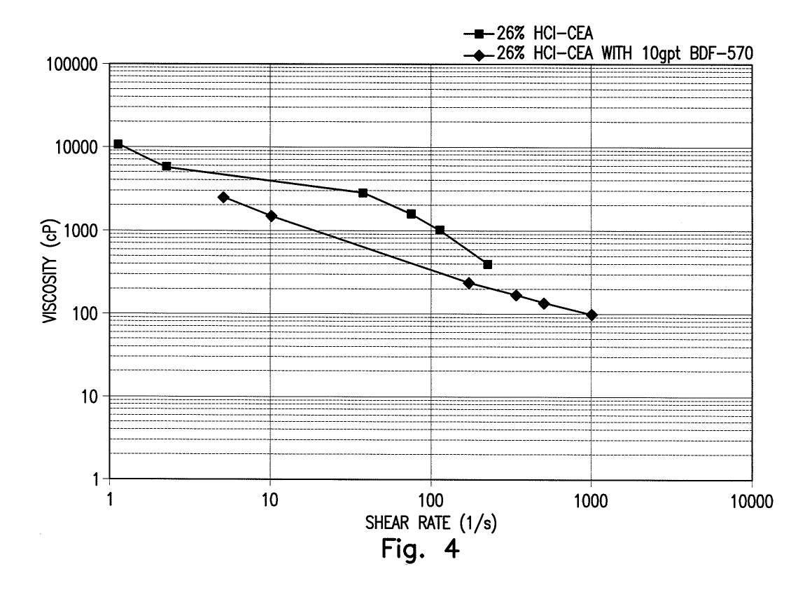

The second viscosity test was a comparison of the base CEA formulation versus the viscosified CEA formulation. The viscosities of the viscosified CEA as described in Table 1 above and the base CEA formulation without the addition of BDF570™ viscosifier were measured at 70° F. The viscosity measurements were taken using a Fann 35 viscometer with an R1B2 rotor-bob at a shear rate of 100 l/s. The results from this test are shown in FIG. 4.

The proppant carrying capacity of the viscosified CEA was also measured. To measure this capacity, 3 ppg of a 30/50 HSP sintered bauxite proppant was added to a volume of the viscosified CEA formulation. The mixture was held at 200° F. with no agitation for one hour, with no visible proppant settling observed.

### Self-Degradable Particulate Addition to Viscosified CEA

For this test, a self-degradable particulate material was added to the viscosified CEA formulation described in Table 1 above to test the degradation of the material. The test was performed using two samples created by adding 5% (wt/vol) of BioVert® NWB to a first volume of the viscosified CEA and 5% (wt/vol) of BioVert H-150 to a second volume of the viscosified CEA. The mixtures were held at 250° F. for two hours and still exhibited uniform mixing. The mixtures were then filtered. The solids collected were dried and weighed to measure the amount of BioVert® NWB and BioVert H-150 degradation. The BioVert® NWB degraded 80.02% and BioVert H-150 degraded 40.28% over the course of this testing.

An embodiment of the present disclosure is a method comprising providing a treatment fluid comprising a base fluid; an acid source; a self-degradable particulate material; and a propping agent; introducing the treatment fluid into a wellbore penetrating at least a first portion of a subterranean formation at or above a pressure sufficient to create or enhance one or more fractures in the subterranean formation; and allowing the self-degradable particulate material to divert at least a portion of the treatment fluid into a second portion of the subterranean formation.

Another embodiment of the present disclosure is a method comprising providing a treatment fluid comprising an emulsion comprising an aqueous internal phase that comprises an acid source; and an oil-based external phase; a self-degradable particulate material; and a propping agent; introducing the treatment fluid into a wellbore penetrating at least a first portion of a subterranean formation at or above a pressure sufficient to create or enhance one or more fractures in the subterranean formation; and allowing the self-degradable particulate material to divert at least a portion of the treatment fluid into a second portion of the subterranean formation.

Another embodiment of the present disclosure is a method comprising providing a treatment fluid comprising an emulsion comprising an aqueous internal phase that comprises hydrochloric acid; and a diesel oil external phase; a self-degradable polyester material; and a propping agent; introducing the treatment fluid into a wellbore penetrating at least a first portion of a subterranean formation at or above a pressure sufficient to create or enhance one or more fractures in the subterranean formation; and allowing the self-degradable particulate material to divert at least a portion of the treatment fluid into a second portion of the subterranean formation.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising:
a base fluid;
an acid source;
a self-degradable particulate material; and
a propping agent;
introducing the treatment fluid into a wellbore penetrating at least a first portion of a subterranean formation at or above a pressure sufficient to create or enhance one or more fractures in the subterranean formation; and
allowing the self-degradable particulate material to divert at least a portion of the treatment fluid into a second portion of the subterranean formation.

2. The method of claim 1 further comprising:
allowing the self-degradable particulate material to at least partially degrade over time in the subterranean formation.

3. The method of claim 1 further comprising introducing a clean fluid into the wellbore in alternating stages with the treatment fluid.

4. The method of claim 1, wherein the treatment fluid further comprises a viscosifier.

5. The method of claim 1, wherein the treatment fluid further comprises a corrosion inhibitor.

6. The method of claim 1, wherein the base fluid comprises an emulsion that comprises an aqueous phase and an oil phase.

7. The method of claim 6, wherein the treatment fluid further comprises an emulsifier.

8. The method of claim 1, wherein the subterranean formation is a carbonate formation.

9. The method of claim 1, wherein the self-degradable particulate material is present in the treatment fluid in an amount ranging from about 0.2 lbm/gal to about 10 lbm/gal.

10. The method of claim 1, wherein the self-degradable particulate material is selected from the group consisting of: a polyester, an orthoester, a poly(orthoester), a polyanhydride, polylactic acid, a dehydrated organic or inorganic compound, anhydrous borate, a salt of organic acid, any combination thereof, and any derivative thereof.

11. The method of claim 1, wherein the acid source is selected from the group consisting of: an inorganic acid, an organic acid, and any combination thereof.

12. The method of claim 1, wherein the treatment fluid comprising the propping agent and the self-degradable particulate material is introduced into the wellbore in pulses or stages, whereby conductive channels are formed in the one or more fractures in the subterranean formation.

13. A method comprising:
providing a treatment fluid comprising:
an emulsion comprising:
an aqueous internal phase that comprises an acid source; and
an oil-based external phase;
a self-degradable particulate material; and
a propping agent;
introducing the treatment fluid into a wellbore penetrating at least a first portion of a subterranean formation at or above a pressure sufficient to create or enhance one or more fractures in the subterranean formation; and
allowing the self-degradable particulate material to divert at least a portion of the treatment fluid into a second portion of the subterranean formation.

14. The method of claim 13, wherein the treatment fluid is introduced into the well bore using a pump and blender system.

15. The method of claim 13, wherein the well bore has a temperature of 550° F. or higher.

16. A method comprising:
providing a treatment fluid comprising:
an emulsion comprising:
an aqueous internal phase that comprises hydrochloric acid; and
a diesel oil external phase;
a self-degradable polyester material; and
a propping agent;
introducing the treatment fluid into a wellbore penetrating at least a first portion of a subterranean formation at or above a pressure sufficient to create or enhance one or more fractures in the subterranean formation; and
allowing the self-degradable particulate material to divert at least a portion of the treatment fluid into a second portion of the subterranean formation.

17. The method of claim 16, wherein the self-degradable polyester material is present in the treatment fluid in an amount ranging from about 0.2 lbm/gal to about 10 lbm/gal.

18. The method of claim 16 further comprising:
allowing the self-degradable polyester material to at least partially degrade over time in the subterranean formation.

19. The method of claim 16, wherein the subterranean formation is a carbonate formation.

20. The method of claim 16, wherein the treatment fluid comprising the propping agent and the self-degradable polyester material is introduced into the wellbore in pulses or stages, whereby conductive channels are formed in the one or more fractures in the subterranean formation.
